(19) United States
(12) Patent Application Publication
(10) Pub. No.: US 2013/0035986 A1
(43) Pub. Date: Feb. 7, 2013

(54) DETERMINING PRODUCT CONFIGURATION AND ALLOCATIONS BASED ON SOCIAL MEDIA POSTINGS

(71) Applicant: TOYOTA MOTOR SALES, U.S.A., INC., Torrance, CA (US)

(72) Inventors: Brian Kursar, Torrance, CA (US); Jayadev Gopinath, Rancho Palos Verdes, CA (US)

(73) Assignee: TOYOTA MOTOR SALES, U.S.A., INC., Torrance, CA (US)

(21) Appl. No.: 13/646,517

(22) Filed: Oct. 5, 2012

Related U.S. Application Data
(60) Provisional application No. 61/709,000, filed on Oct. 2, 2012.

(51) Int. Cl. G06Q 30/02

(52) U.S. Cl. 705/7.31

(57) ABSTRACT

A system may determine configurations and/or allocations of products. The system may include a computer data processing system that may be configured to: query a computer system for social media postings made in a social media network system that are about one or more of the products; determine which of the products are likely to be most in demand based on the results of the query; and store information indicative of the determination.

### CROSS-REFERENCE TO RELATED APPLICATION

This application is based upon and claims priority to U.S. provisional patent application 61/709,000, entitled “PRIORITIZING MARKETING LEADS, DETERMINING PRODUCT CONFIGURATION AND ALLOCATIONS, AND VALIDATING CUSTOMER COMPLAINTS BASED ON SOCIAL MEDIA POSTINGS,” filed Oct. 2, 2012, attorney docket number 064666-0078. The entire content of this application is incorporated herein by reference.

### BACKGROUND

1. Technical Field

This disclosure relates to determining product configurations and allocations and to social media postings.

2. Description of Related Art

Businesses, such as automotive manufactures and distributors, must determine which products to manufacture, such as which brands, series, models, colors, and/or configurations of vehicles. Business that have multiple sales outlets, such as automobile dealerships, must also determine how to allocate these manufactured products among their various outlets.

A primary factor in these determinations is often a prediction of which products are likely to be in most in demand and in what geographic areas. Unfortunately, it can be very difficult to predict these demands accurately. This can result in manufactured product that is unwanted and an insufficient supply of wanted product.

### SUMMARY

A system may determine configurations and/or allocations of products. The system may include a computer data processing system that may be configured to: query a computer system for social media postings made in a social media network system that are about one or more of the products; determine which of the products are likely to be most in demand based on the results of the query; and store information indicative of the determination.

The computer data processing system may be configured to tag each social media posting that contains information relevant to which of the products are likely to be most in demand.

The computer data processing system may be configured to: determine which product options are likely to be most in demand based on the results of the query; and store information indicative of which product options are likely to be most in demand.

The computer data processing system may be configured to: determine which product color or colors are likely to be most in demand based on the results of the query; and store information indicative of which product color or colors are likely to be most in demand.

The computer data processing system may be configured to: determine a location of the author of each of the social media postings that are about one or more of the products; and determine which of the products are likely to be most in demand at each of multiple locations based on the results of the query and the location determinations; and store information indicative of which of the product are likely to be most in demand at each of the multiple locations.

The computer data processing system may be configured to: identify each social media posting that contains information indicative of a positive or negative sentiment about one of the products; and determine which of the products are likely to be most in demand based at least in part on the identified sentiments.

The computer data processing system may be configured to: identify each social media posting that contains information indicative of an intention to purchase one of the products; and determine which of the products are likely to be most in demand based at least in part on the identified intentions to purchase.

The computer data processing system may be configured to: identify each social media posting that contains information indicative of a comparison between two of the products; and determine which of the products are likely to be most in demand based at least in part on the identified comparisons.

The computer data processing system may be configured to: identify each social media posting that contains information indicative of a comparison between two of the products; determine whether each identified comparison is between products within substantially the same class; and determine which of the vehicle models are likely to be most in demand based at least in part on the same class determinations.

The computer data processing system may be configured to: query the computer system for social media postings in the social media network that were made to each of the authors of the social media postings that are about one or more of the products; identify those social media postings made to each of the authors that contain information indicating a recommendation for or against a particular one of the products; and determine which of the products are likely to be most in demand based at least in part on the identified recommendations.

The computer data processing system may be configured to obtain the social media postings made to each of the authors by querying the computer system for social media postings that were made in response to social media postings made by each of the authors.

The computer data processing system may be configured to obtain the social media postings made to each of the authors by querying the computer system for social media postings made to each author in an area of the social media network system dedicated to each of the authors and in which others may post postings.

The computer data processing system may be configured to: identify each social media posting that contains information indicative of an event in the life of each author of the social media posting that is relevant to determining whether each author is likely to purchase one of the products; and determine which of the products are likely to be most in demand based at least in part on the identified events.

The computer data processing system may be configured to: identify each social media posting that contains information indicative of a visit to a product dealer by each of authors of the social media postings; and determine which of the products are likely to be most in demand based at least in part on the identified visits.

The computer data processing system may be configured to: verify the accuracy of the information indicative of the visit to each product dealer; and determine which of the products are likely to be most in demand based at least in part on the verifications.

A non-transitory, tangible, computer-readable storage medium may contain a program of instructions configured to cause a computer data processing system running the program of instructions to determining configurations and/or allocations of products, and, in particular, to perform any combination of the functions recited above.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of a business information system that uses social media postings to assist in making business-related determinations, including prioritizing marketing leads, configuring and allocating products, and validating customer complaints.

FIG. 2 illustrates an example of a process that may be implemented by the business information system illustrated in FIG. 1, including by the marketing lead prioritization system, the product configuration/allocation system, and the customer complaint validation system.

FIG. 3 illustrates an example of the marketing lead prioritization system illustrated in FIG. 1.

FIG. 4 illustrates an example of a process that may be implemented by the marketing lead prioritization system illustrated in FIG. 3, such as by the computer data processing system.

FIG. 5 illustrates an example of search term variations that may be used to identify social media postings that reference a product brand and a tag value that may be associated with each social media posting that contains a match.

FIG. 6 illustrates an example of search term variations that may be used to identify social media postings that reference a competitive product brand and a tag value that may be associated with each social media posting that contains a match. “Competitive” includes a company that is in competition with the company that is analyzing the social media postings.

FIG. 7 illustrates an example of search term variations that may be used to identify social media postings that reference a product brand series and a tag value that may be associated with each social media posting that contains a match.

FIG. 8 illustrates an example of search term variations that may be used to identify social media postings that reference a competitive product brand series and a tag value that may be associated with each social media posting that contains a match.

FIG. 9 illustrates an example of search term variations that may be used to identify social media postings that reference a product model year and a tag value that may be associated with each social media posting that contains a match.

FIG. 10 illustrates an example of search term variations that may be used to identify social media postings that indicate an intent to purchase and a tag value that may be associated with each social media posting that contains a match.

FIG. 11 illustrates an example of search term variations that may be used to identify social media postings that indicate a comparison between different products and a tag value that may be associated with each social media posting that contains a match.

FIG. 12A illustrates an example of a product classification that may be associated with each of several products.

FIG. 12B illustrates an example of a tag value that may be associated with each social media posting that contains a comparison between products that are identified within the table in FIG. 12A as being within the same class.

FIG. 13 illustrates an example of search term variations that may be used to identify social media postings that indicate a decision to purchase a product and a tag value that may be associated with each social media posting that contains a match.

FIG. 14 illustrates an example of search term variations that may be used to identify social media postings that reference a product dealer and a tag value that may be associated with each social media posting that contains a match.

FIG. 15 is an example of data that is representative of a social media posting that may be returned in partial response to an API query for social media postings meeting the requirements of the query, reflected in FIG. 15, this data may include a geocode indicating the location at which the posting was made.

FIG. 16 illustrates an example of search term variations that may be used to identify social media postings that indicate an event in the life of an author of a social media posting that suggests that the author is a good candidate for the marketing approach, as well as a tag value that may be associated with each social media posting that contains a match.

FIG. 17 illustrates an example of search term variations that may be used to identify social media postings that indicate an event in the life of an author of a social media posting that suggests that the author is not a good candidate for the marketing approach, as well as a tag value that may be associated with each social media posting that contains a match.

FIGS. 18A-25A illustrate examples of a social media postings.

FIG. 26 sets forth an example of how various tag values that may be associated with a single social media posting concerning a marketing lead prospect may be weighted when scoring the social media posting. Algorithms that assign different weights, utilize a different set of tags, and/or that have different or no mandatory tag requirements may be used instead.

FIG. 27 lists an example of how various tag values that may be associated with internal data from the internal databases and that concern the author of the social media posting may be weighted when scoring the social media posting.

FIG. 28 illustrates an example of the product configuration/allocation system illustrated in FIG. 1.

FIG. 29 illustrates an example of a process that may be implemented by the product configuration/allocation system illustrated in FIG. 28, such as by the computer data processing system.

FIGS. 30A, 30B, 32A, and 32B collectively set forth an example of how various tag values that may be associated with a single social media posting may be weighted when scoring the social media posting for its effect on allocations of product series, product years, product models, product accessories, and product colors.

FIGS. 31 and 33 collectively set forth an example of how various tag values that may be associated with internal data from internal databases and that concern the author of the social media posting may effect the same product allocations.

FIG. 34 illustrates an example of the customer complaint validation allocation system illustrated in FIG. 1.

FIG. 35 illustrates an example of a process that may be implemented by the complaint validation allocation system illustrated in FIG. 34, such as by computer data processing system.

FIG. 36 illustrates an example of tags that may each be associated with social media postings that reference an aspect of a product that is described by the tag. Each tag may be associated with a list of term variations that are considered indicative of the aspect of the product that is referenced by the tag.

FIG. 37 presents an example of how various tag values that may be associated with a social media posting concerning a product complaint may be weighted when scoring the social media posting. Other algorithms that assign different weights, utilize a different set of tags, and/or that have different or no mandatory requirements may be used instead.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

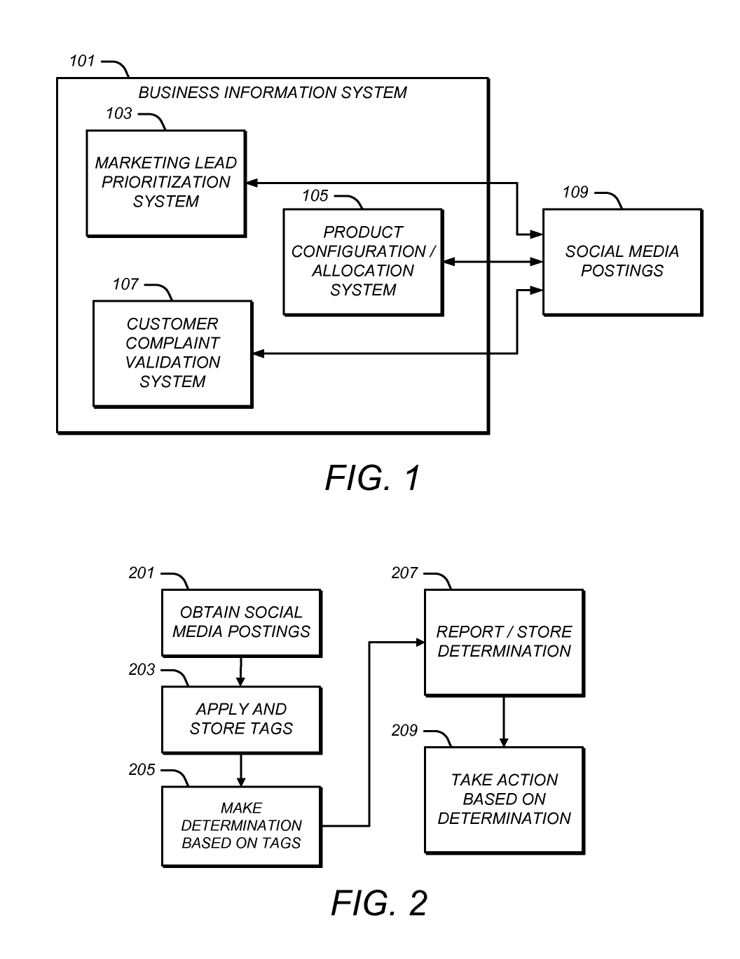

FIG. 1 illustrates an example of a business information system 101 that uses social media postings 109 to assist in making business-related determinations, including prioritizing marketing leads, configuring and allocating products, and validating customer complaints.

As illustrated in FIG. 1, the business information system 101 may include a marketing lead prioritization system 103, a product configuration/allocation system 105, and a customer complaint validation system 107. The marketing lead prioritization system 103 may be configured to determine which marketing lead prospects are good candidates for a marketing effort. The product configuration/allocation system 105 may be configured to determine which products are likely to be most in demand. (Except when qualified by other surrounding language, the word “product,” as used herein, includes a product brand, a product series, a product model, and a particular product configuration (such as with one or more accessories, in one or more configurations, and/or in one or more colors). The word “product” is also intended to include a service.) The customer complaint validation system 107 may be configured to determine how widespread complaints are about products. Each of these systems may be configured to make their determinations based at least in part on information within the social media postings 109. The business information system 101 may include other systems that make other determinations that may be relevant to a business, also based on information within the social media postings 109.

The marketing lead prioritization system 103, the product configuration/allocation system 105, and the customer complaint validation system 107 are all illustrated in FIG. 1 as being part of the business information system 101. However, one or more of these system may instead be completely separate from the business information system 101 and/or may be part of another system.

The social media postings 109 may come from one or more social media network systems. The social media network systems may be of any type. For example, the social media network systems may be collaborative projects, such as Wikipedia™, blogs, and microblogs (e.g., Twitter™); content communities (e.g., YouTube™); social networking sites (e.g., Facebook™, Google+™, MySpace™, or Bebo™); virtual game worlds (e.g., World of Warcraft™); and/or virtual social worlds (e.g., Second Life™).

Each social media posting may include text, one or more images, and/or one or more multimedia files. Each social media posting may also include metadata, such as an identification of its author, demographic or other information about its author, an identification of the social media network system on which it was created, the date and time of its creation, and/or a geocode indicative of the geographic location at which it was created. The geocode may be provided by an application that was used to create the posting, such as Foursquare™, Facebook™, or Yelp Checking™.

FIG. 2 illustrates an example of a process that may be implemented by the business information system 101 illustrated in FIG. 1, including by the marketing lead prioritization system 103, the product configuration/allocation system 105, and the customer complaint validation system 107. This process may also be implemented by a different type of system. Similarly, the business information system 101 illustrated in FIG. 1 may implement a different process.

The process may obtain social media postings that may be relevant to a determination that is to be made, as reflected by an Obtain Social Media Postings step 201. To facilitate this step, the business information system 101, or a system within it that is seeking to make the determination, may issue a query to one or more computer systems (not shown) for the desired social media postings. The queried computer system(s) may contain the social media postings 109 in one or more computer data storage systems. For example, one of the queried computer systems may be a social media network system that contains the social media postings 109 or a third party system that stores copies of these postings. One or more of the queried computer systems may instead itself query another computer system for the desired social media postings and return what is received in response.

The query that is sent by the business information system 101, or by one of the systems within it, may be configured to seek social media postings that match one or more search terms in one or more fields of information that are associated with the social media postings, such as in a text field and/or a metadata field, such as a metadata field containing information identifying the author of the social media posting. When more than one search term is used in a query, the query may specify a desired logical relationship between them.

Any technology may be used to formulate and issue the query and to receive the requested social media postings in response. For example, the query may utilize an API that is provided for this purpose by the queried computer system. A web crawler may in addition or instead be employed to obtain the desired social media postings. An example of such a web crawler is OpenSource Apache Nutch.

The query that is used to obtain the social media postings may be formulated by using information from one or more sources, such as one or more internal or external databases. Examples of such external databases include Fliptop™ and Pipl™. A query for information from one database may result in information that is used for a query for information from another database and so forth until the information needed for the query for the social media postings is obtained.

To minimize the complexity of the query and/or to reduce the number of queries that must be sent, the query may be configured to retrieve a large block of social media postings, only some of which may be relevant to the determination that is to be made. The large block of social media postings that are retrieved may then be queried by the business information system 101, or by one of its systems, one or more additional times to identify those social media postings within them that may be relevant to the desired determination.

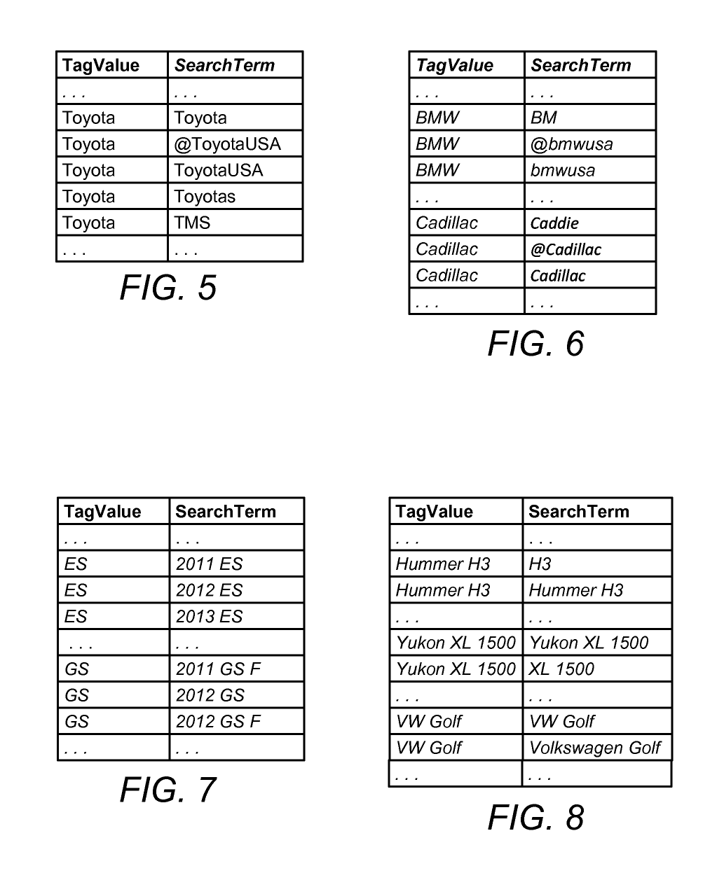

Each potentially relevant social media posting that is ultimately identified may then be associated with one or more tag values, which may then be stored in a computer data storage system, as reflected by an Apply and Store Tags step 203. Each tag value may indicate a relevant aspect of the social media posting. Variations in the way the same relevant aspect is expressed in different social media postings may be assigned the same tag value, thereby normalizing these differences. FIG. 5 illustrates examples.

To facilitate this tagging, the retrieved social media postings may be queried to identify those that contain one or more search terms. When multiple search terms are used to identify a single relevant aspect of the social media postings, the multiple search terms may be combined in the query with Boolean logical connectors.

Sophisticated text, sound, and or image analytics software may also or instead be used to identify and tag the relevant aspects of the social media postings. Examples of such analytics software include natural language processing software that identifies and tags meaningful information from natural language; sentiment analysis software that identifies and tags whether a positive or negative sentiment is being expressed about a particular subject; and named entity recognition software that identifies and tags a subject of interest, such as a name of a dealer, brand, series, model, person, organization, or location, or a time, quantity, or value.

Information from other databases may also be queried for supplemental information that may be relevant. The other databases may include internal databases, as well as external databases, such as Experian™, Pipl, and Fliptop™. This supplemental information may similarly be tagged with values, each of which indicate a relevant aspect of the supplemental information. Variations in the way the same relevant aspect is expressed may be assigned the same tag value, thereby normalizing these differences. The same type of search term searching and/or analytics software that was discussed above in connection with tagging the social media postings may be used here as well.

The various tags may then be analyzed for the purpose of making the desired determination, as reflected by a Make Determination Based On Tags step 205.

Each tag may be assigned a positive, negative, or neutral weight in connection with its effect on the determination to be made. The presence or absence of various combinations of tags may similarly be assigned a positive, negative, or neutral weight.

A positive, negative, or neutral weight may also be assigned to aggregate information, such as to the number and/or frequency of identical tags. The dates of the data that is tagged, such as the social media postings, may also be factored in (e.g., later dates receiving more weight than earlier dates). The determination may also be based on other factors in addition or instead.

The magnitude of one weight may be the same as or different from the magnitude of another weight. In other words, some tags or missing tags and/or combination of these may be given more weight in the determination than others.

For some determinations, there may be one or more mandatory tags that, if not present in a particular social media posting or in supplemental information relating to it, may cause the social media posting not to be given any weight. One example are tags that identify a product series and an intent to purchase. Both may be mandatory before a social media posting is given weight when determining whether the author of the posting is a good candidate for a marketing approach.

The results of the determination may be reported in one or more printed or displayed reports and/or stored in a computer data storage system for future reference, as reflected by Report/Store Determination step 207.

Action may be taken based on the determination that is made, as reflected by a Take Action Based On Determination step 209.

The process of querying for social media postings and making determinations based on the information that is returned may be repeated on a periodic, on-demand, and/or other basis.

One example of the marketing lead prioritization system 103, the product configuration/allocation system 105, and the customer complaint validation system 107 will now be presented, along with one example of a process that each may implement. Each of these systems and processes may be instead be different.

Examples of search term variations that may be used to identify relevant social media postings, as well as tag values that may be associated with each social media posting that contains a match, will also now presented. Although each example may only be presented in connection with one of the systems that within the business information system 101, the same search term variations and/or tag values may be used in connection with the other systems and given weight when making the determinations that they make.

Each of these example search terms may be used as part of the initial query for the social media postings and/or during an analysis of the social media postings that are returned in response to a broader initial query. Most of the example tag values that are now presented are based on matching search terms. However, natural language processing software, sentiment analysis software, and/or named entity recognition software may be used in addition or instead to identify and tag each of the relevant social media postings in the ways that are discussed, as well as in other ways.

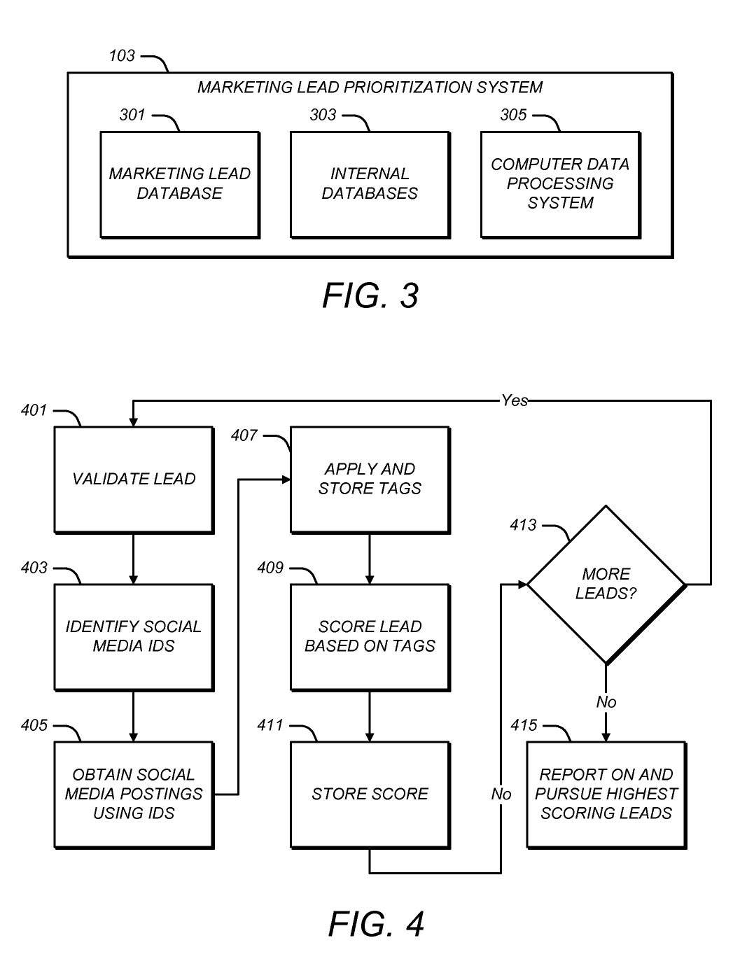

FIG. 3 illustrates an example of the marketing lead prioritization system 103 illustrated in FIG. 1. As explained above, the marketing lead prioritization system 103 may be configured to determine which marketing lead prospects are good candidates for a marketing effort.

As illustrated in FIG. 3, the marketing lead prioritization system may include a marketing lead database 301, internal databases 303, and a computer data processing system 305.

The marketing lead database 301 may contain marketing leads. Each marketing lead may identify a prospect for the marketing approach. The marketing lead database 301 may be distributed across several locations and may include marketing leads gathered during dealer visits; visits to promotional websites of manufacturers, distributors, and/or dealers; visits to associate websites; trade shows; other types of events; and/or that were purchased or otherwise obtained from third parties.

Each marketing lead may include the name of a marketing prospect, as well as his or her residential and/or business addresses; residential, business, and/or mobile phone numbers; and/or personal and/or business e-mail addresses. Each marketing lead may also include one or more social network IDs for the prospect and, for each, an identification of a social media network system that is associated with it.

The internal databases 303 are an example of the other databases discussed above. They may contain supplemental information that is relevant to determining which social media postings are relevant to whether a marketing lead is a good candidate for the marketing effort. For example, the internal databases 303 may include information about the marketing leads. The internal databases 303 may include one or more customer sales databases, customer leasing databases, customer relations databases, and/or survey databases. Collectively, for example, the internal databases 303 may contain information indicative of whether a lead and/or a member of the lead's household or family is an existing customer and, if so, for what product brand, the date of the product's purchase or lease, the date any lease may expire, any sentiments expressed during a survey, and whether any customer relation experience was positive or negative.

The computer data processing system 305 may be configured to perform the operations of the marketing lead prioritization system 103 that have been described herein, such as to issue queries, receive social media postings in response, associate tags, make determinations, and to cause actions to be taken based on the determinations. The computer data processing system 305 may also be configured to perform each of the steps of the process illustrated in FIG. 4.

FIG. 4 illustrates an example of a process that may be implemented by the marketing lead prioritization system illustrated in FIG. 3, such as by the computer data processing system 305. This process may also be implemented by a different type of system. Similarly, the marketing lead prioritization system 103 illustrated in FIG. 3 may implement a different process.

The computer data processing system 305 may attempt to validate a marketing lead that is to be analyzed, as reflected by a Validate Lead step 401. During this step, the computer data processing system 305 may examine each street address, phone number, email address, and/or social media ID that has been provided as part of the marketing lead—or that has been obtained from one of the internal databases 303 based on information in the lead—to verify that it is a valid street address, phone number, email address, and/or social media ID. The computer data processing system 305 may designate a marketing lead that contains invalid information as one that is not a good candidate for the marketing effort and not consider it further.

If the lead appears to be valid, on the other hand, the computer data processing system 305 may make an effort to identify one or more social media IDs of the prospect that is the subject of the lead, as reflected by an Identify Social Media IDs step 403. This step may also include identifying social media IDs of others that may likely provide advice to the prospect, such as members of the prospects family and/or household.

The computer data processing system 305 may be configured to obtain these social media IDs from any source, such as from the marketing lead itself, one of the internal databases 303, an external database, such as Pipl™, and Fliptop™ and/or from a third party provider of social media IDs. The computer data processing system 305 may do so by providing one or more of these sources with information about the prospect, such as a name, phone number, email address, and/or a street address, and receiving the social media IDs in response. As an interim step, the computer data processing system 305 may be configured to seek information about a prospect, such as phone number, email address, and/or a street address, from one of the internal or external databases, by providing a name or other information, and to deliver the information that is received in response to a different system to get the social media IDs.

The computer data processing system 305 may be configured to obtain the social media postings made by the person with these IDs (including, when determined, the members of his or her family and/or household), as reflected by an Obtain Social Media Postings Using IDs step 405. This may be done by the computer data processing system 305 formulating and causing one or more queries to be delivered to one or more sources of these social media postings, as more specifically described above, and receiving the social media postings in response.

The computer data processing system 305 may then analyze the social media postings that are received in response, tag those that contain information that may be relevant to whether each prospect is a good candidate for the marketing effort with values indicative of the relevancy, and store these tags, as reflected by an Apply and Store Tags step 407.

A broad variety of different types of information within the social media postings may be indicative of the potential relevance of the social media posting to determining whether the prospect is a good candidate for the marketing effort. This may include information relating to an identification of products, purchase lifecycles, trusted recommendations, dealer visits, purchase target locations, life events, and other types of information. Examples of each of these are now provided.

As indicated, one class of information that may be relevant is when the social media posting makes reference to a product of interest. This reference may be to a product brand, series, and/or model. Consideration may also be given to whether the reference is to a new or to a used product. FIG. 5 illustrates an example of search term variations that may be used to identify social media postings that reference a product brand and a tag value that may be associated with each social media posting that contains a match. As illustrated in FIG. 5 and in many of the following figures, different language in social media postings may be in reference to the same thing. In such a case, each variation may be associated with the same tag value, thereby eliminating the confusion that might otherwise be caused by the language variations during a subsequent determination step.

FIG. 6 illustrates an example of search term variations that may be used to identify social media postings that reference a competitive product brand and a tag value that may be associated with each social media posting that contains a match. “Competitive” includes a company that is in competition with the company that is analyzing the social media postings.

FIG. 7 illustrates an example of search term variations that may be used to identify social media postings that reference a product brand series and a tag value that may be associated with each social media posting that contains a match.

FIG. 8 illustrates an example of search term variations that may be used to identify social media postings that reference a competitive product brand series and a tag value that may be associated with each social media posting that contains a match.

Comparable search term variations and associated tags may be used to identify social media postings that reference a product model and/or a competitive product model.

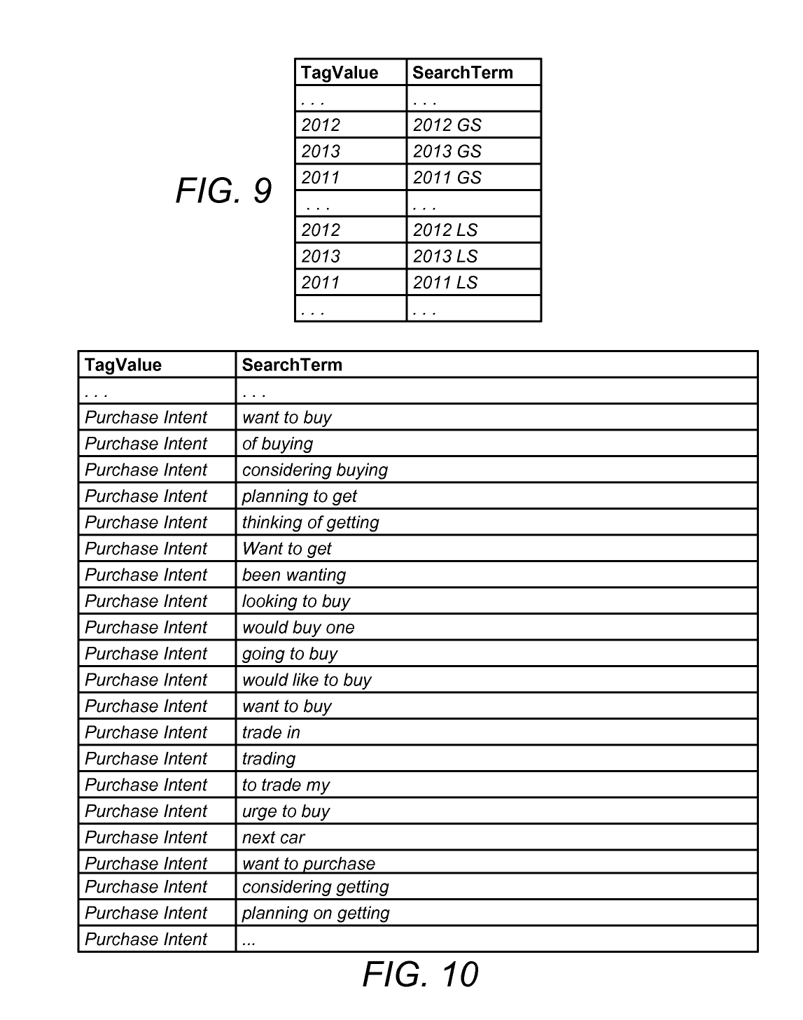

FIG. 9 illustrates an example of search term variations that may be used to identify social media postings that reference a product model year and a tag value that may be associated with each social media posting that contains a match.

Comparable search term variations and associated tags may be used to identify social media postings that express a positive or negative sentiment about a product brand, series, or model and/or a competitive product brand, series, or model. Sentiment analysis software may also or instead be used to identify such social media postings.

Search term variations and associated tags may also be used to identify social media postings reflecting acts that take place within a purchase lifecycle that may be indicative of a promising marketing lead, such as postings that reflect an intent to purchase a product, an intent to test a product, a report of a product test (e.g., a vehicle test drive), a comparison between different products, and a decision to purchase a product.

FIG. 10 illustrates an example of search term variations that may be used to identify social media postings that indicate an intent to purchase and a tag value that may be associated with each social media posting that contains a match. Additional search terms and/or natural language processing software may be used to identify any urgency or lack of urgency that may be associated with the intent to purchase and an appropriate tag value may be added to each of such social media postings reflecting this urgency determination.

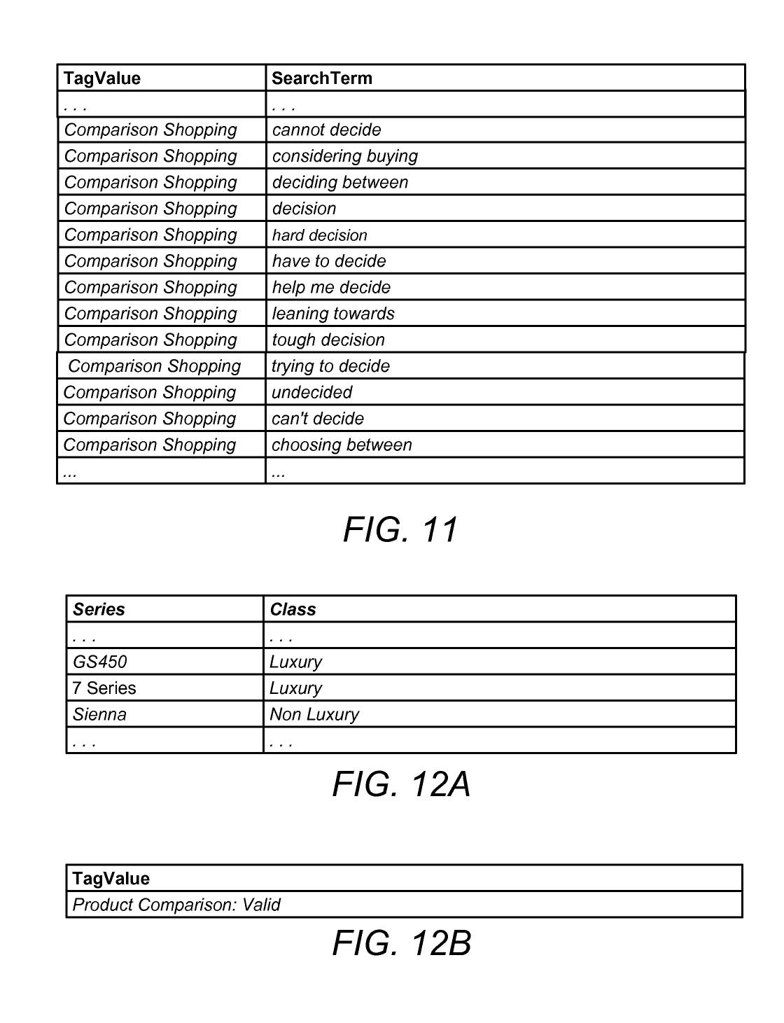

FIG. 11 illustrates an example of search term variations that may be used to identify social media postings that indicate a comparison between different products and a tag value that may be associated with each social media posting that contains a match.

FIG. 12A illustrates an example of a product classification that may be associated with each of several products. Other types of classifications may be used in addition or instead, such as price bracket classifications (e.g., expensive, average, or inexpensive), and/or product application classifications (e.g., racing, family, cargo).

FIG. 12B illustrates an example of a tag value that may be associated with each social media posting that contains a comparison between products that are identified within the table in FIG. 12A as being within the same class. As illustrated in FIG. 12B, if compared products are within the same class, the social media posting in which the comparison is made may be tagged as “Product Comparison: valid” or with other language having a similar meaning. Otherwise, the social media posting may be tagged as “Product Comparison: invalid” or with other language having a similar meaning.

FIG. 13 illustrates an example of search term variations that may be used to identify social media postings that indicate a decision to purchase a product and a tag value that may be associated with each social media posting that contains a match.

Efforts may also be made to locate, identify, and tag social media postings that are made to a marketing lead prospect that contain a recommendation for or against a product. The query to locate such postings may be limited to social media postings that are made in response to a social media posting authored by the marketing lead prospect and/or that are made within an area in a social media network system that is dedicated to the prospect and in which others may post postings. Examples of search terms that may be used to identify such social media postings include “I recommend” and “I would go with.”

Efforts may also be made to identify and tag whether the recommendation has been made by a person that is likely to be trusted by the prospect, such as by a member of the prospect's family and/or household and/or a person that the prospect has identified as a friend in a social media network system. Family or household memberships may be determined by consulting the internal databases 303, external databases, and/or by any other means. Each of these social media postings may also be evaluated and tagged with values that indicate whether the basis of the recommendation is subjective (i.e., the author's opinion) or objective (i.e., a statement of fact). For example, the recommendation might state “The new Camry is a great deal” (subjective) or “The new Camry is competitively priced based on price comparisons found in Edmunds.” Analytics software, such as Lexalytics™ may be used for this purpose. Consideration may also be given to social media postings that indicate that a visit to a product dealer has been made or is planned.

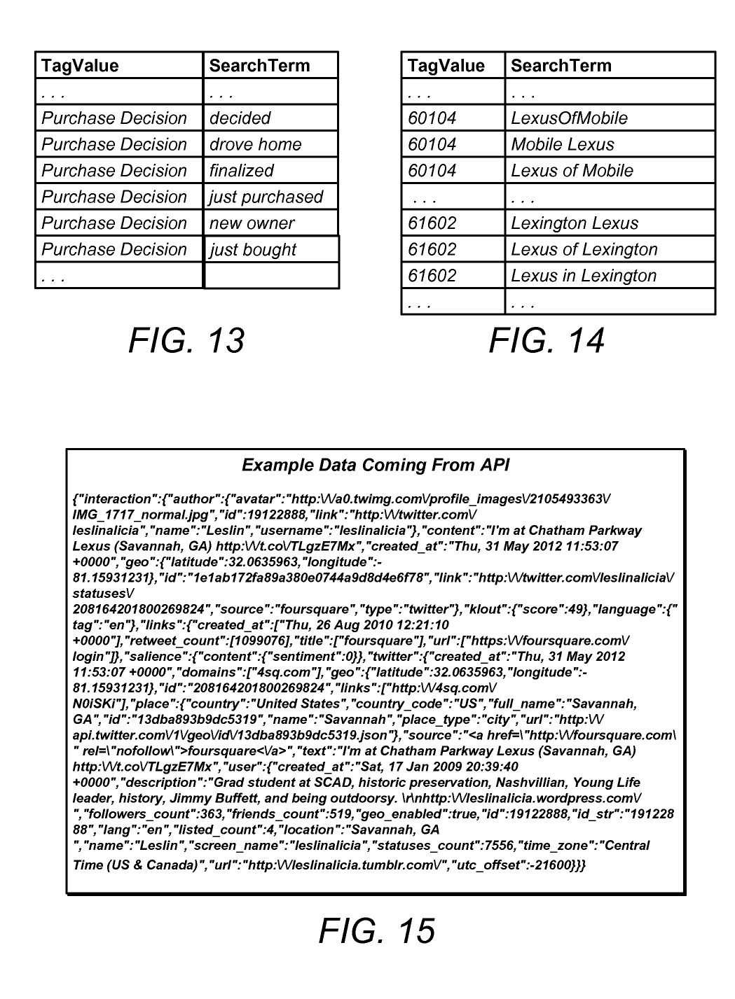

FIG. 14 illustrates an example of search term variations that may be used to identify social media postings that reference a product dealer and a tag value that may be associated with each social media posting that contains a match. In this example, the tag values represent a unique coded number that is associated with each dealer.

A social media posting may indicate that its author is currently visiting a product dealer. When so indicated, an effort may be made to validate that accuracy of that posting.

Any means may be used to validate the accuracy of a social media posting that indicates that a dealer visit is currently taking place. For example, a geocode may be associated with the posting indicating where the posting was made. The location of the geocode may then be determined and compared to the known location of the product dealer that is purportedly being visited. The significance of the posting may be downgraded or ignored if the two do not match. An appropriate tag value may be associated with the posting indicative of the results of this comparison to preserve this information.

FIG. 15 is an example of data that is representative of a social media posting that may be returned in partial response to an API query for social media postings meeting the requirements of the query, reflected in FIG. 15, this data may include a geocode indicating the location at which the posting was made.

Comparable search term variations and associated tags may be used to identify social media postings that express a positive or negative sentiment about a product dealer. Sentiment analysis software may also or instead be used to identify such social media postings.

Various events in the life of a marketing lead prospect may also be considered in determining whether the lead is a good candidate for a marketing effort.

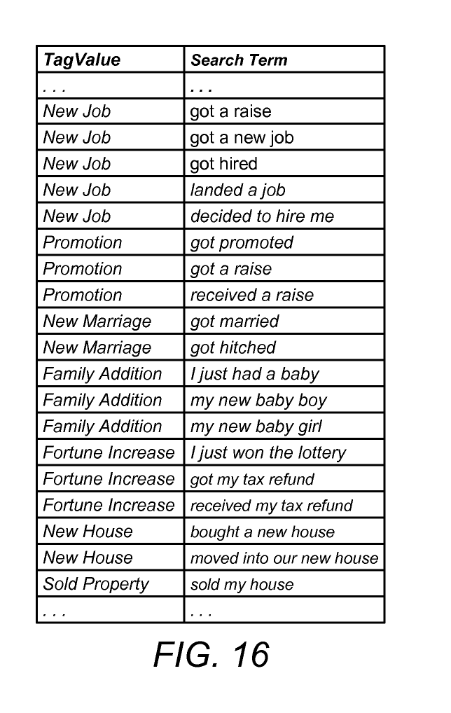

FIG. 16 illustrates an example of search term variations that may be used to identify social media postings that indicate an event in the life of an author of a social media posting that suggests that the author is a good candidate for the marketing approach, as well as a tag value that may be associated with each social media posting that contains a match.

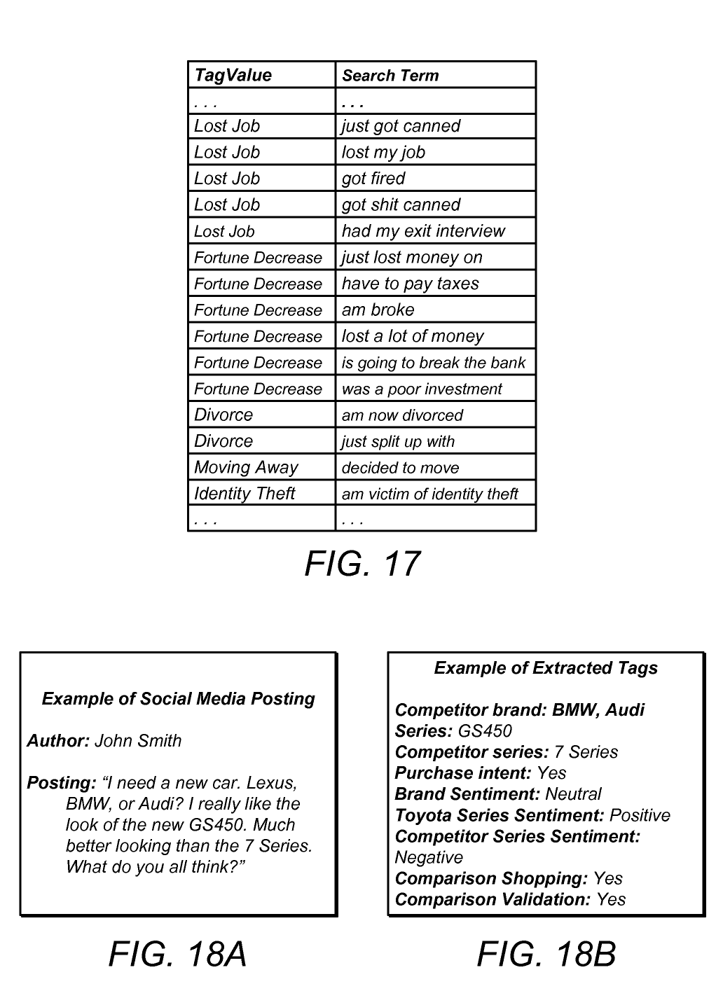

FIG. 17 illustrates an example of search term variations that may be used to identify social media postings that indicate an event in the life of an author of a social media posting that suggests that the author is not a good candidate for the marketing approach, as well as a tag value that may be associated with each social media posting that contains a match.

Comparable search terms and associated tags may be used to identify social media postings that disclose (in either the postings or metadata associated with the postings) information about the author of the postings, such as demographic information (e.g., age, profession, income, location), household and/or family members of the author, and/or dates of the postings. All or portions of the same information may be sought and tagged from other sources, such as internal or other external databases, such as the ones described above.

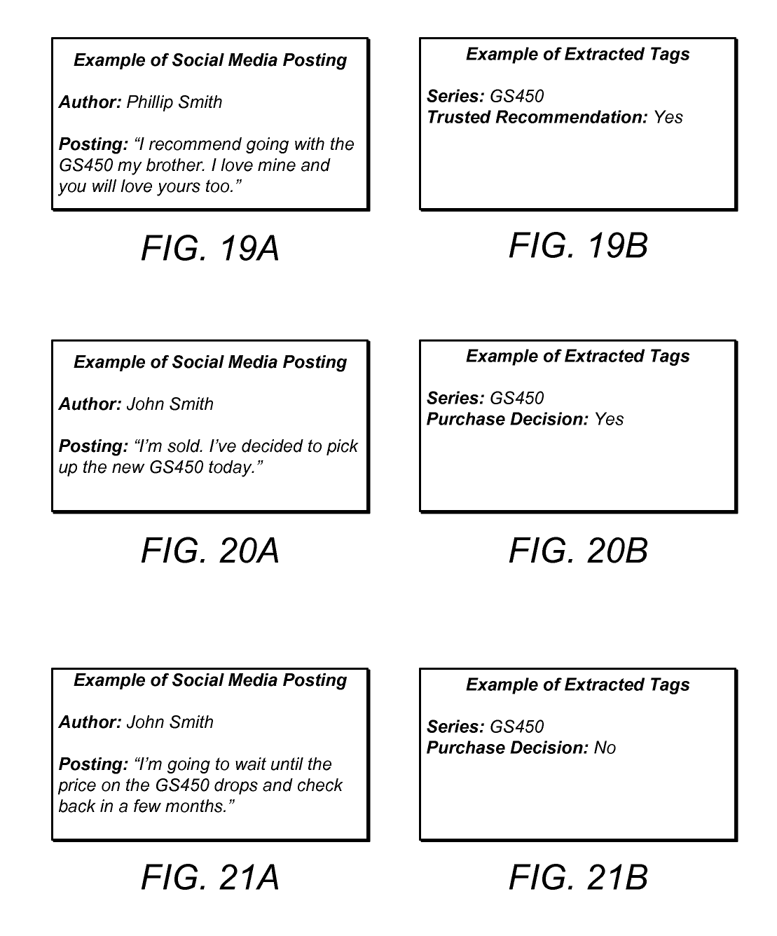

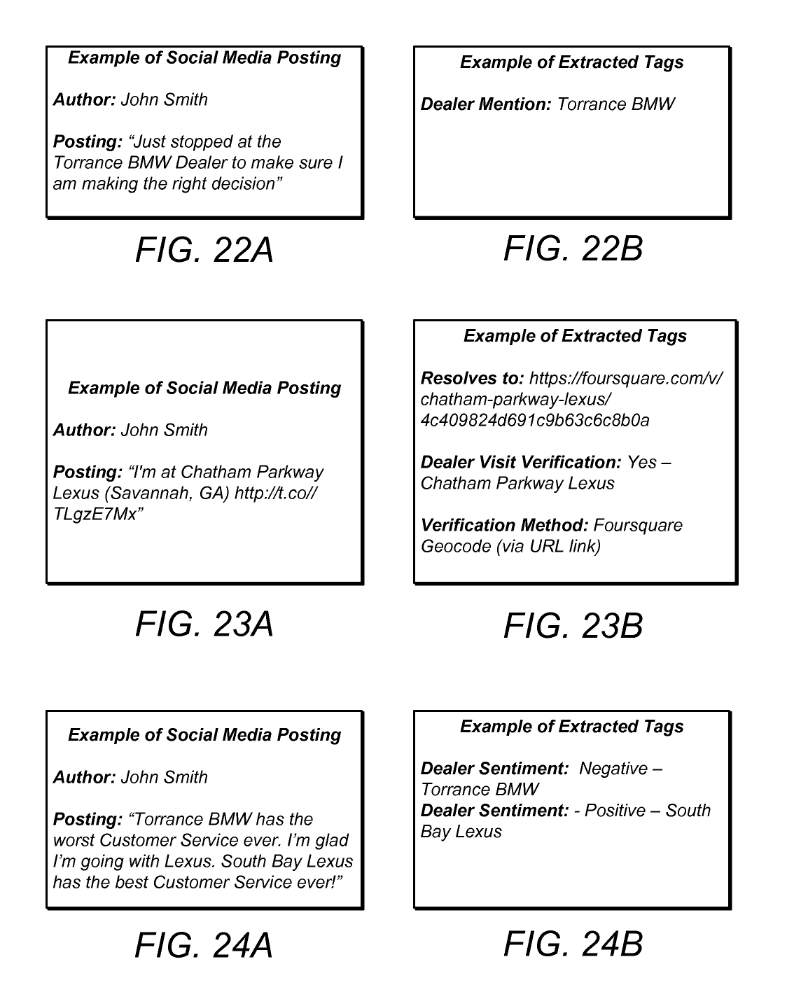

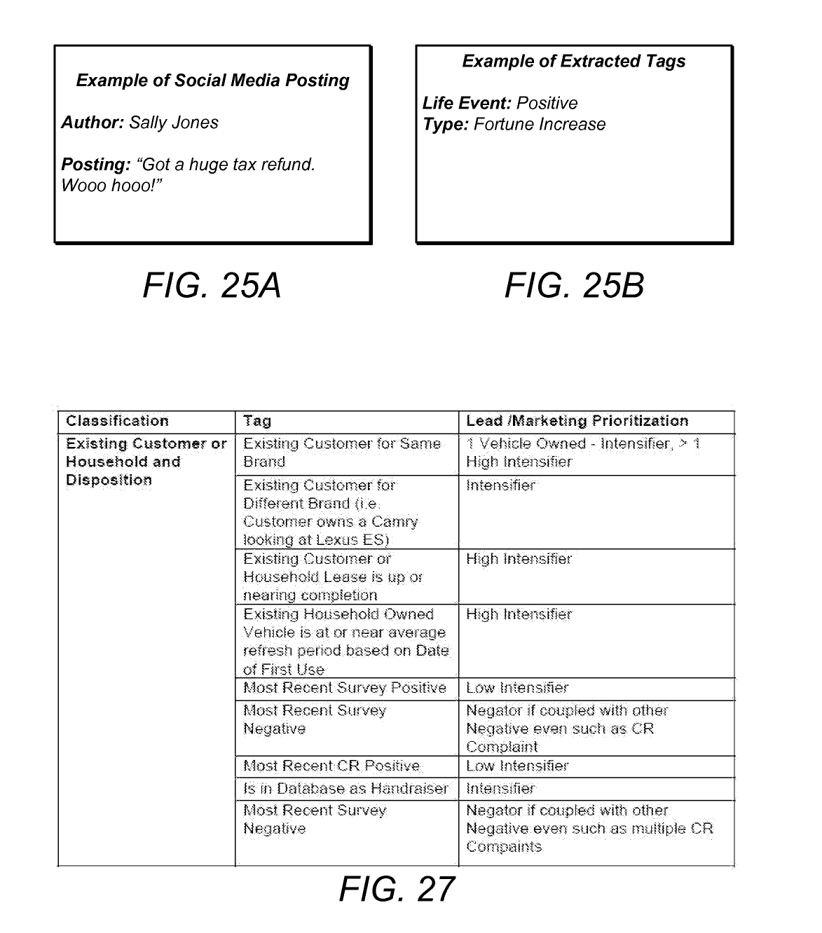

FIGS. 18A-25A illustrate examples of a social media postings. FIGS. 18B-25B illustrate examples of tag values that may be associated with these social media postings, respectively, based on their content matching search terms that were associated with each tag value, many of which are illustrated in the search term examples discussed above. FIG. 23B illustrates a tag indicating that a social media posting about a current dealer visit has been verified, meaning that it was sent at the dealer's location. Other information about the verification is contained in other tags. FIGS. 24B and 25B illustrate positive and negative sentiment tags, respectively, that may be detected by sentiment analysis software.

The computer data processing system 305 may then score the marketing lead based on the tags that have been associated with both the social media postings and the supplemental information, as reflected by a Score Lead Based On Tags step 409. The score may indicate the degree to which the prospect is a good candidate for the marketing effort in comparison to other prospects.

The computer data processing system 305 may employ any algorithm for scoring the lead. The scoring algorithm may implement any of the approaches discussed above in connection with the Make Determination Based on Tags step 205.

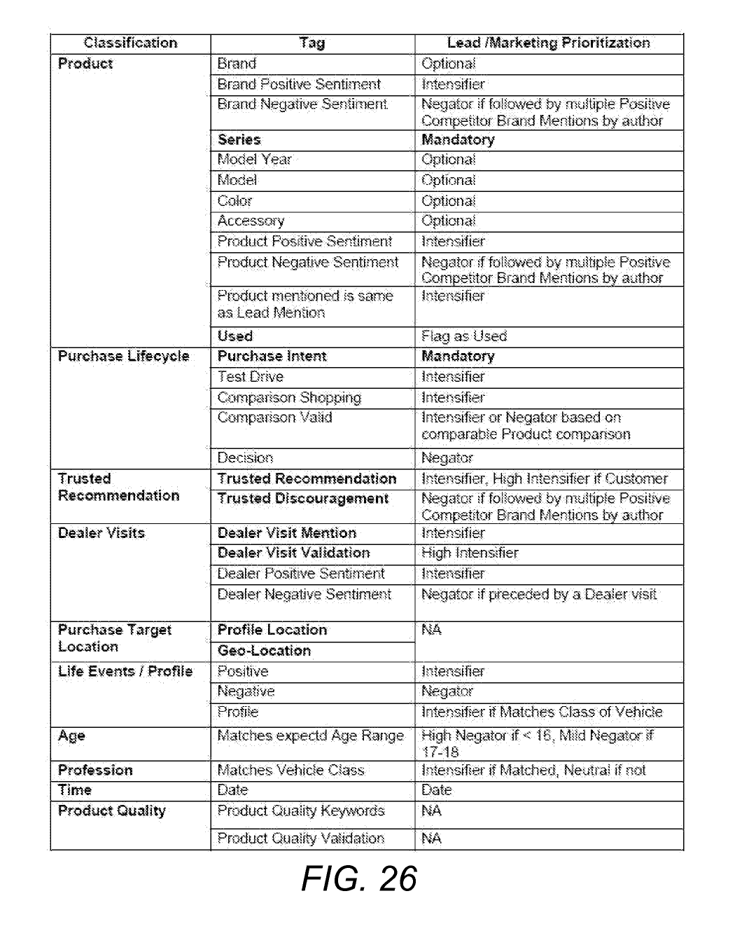

FIG. 26 sets forth an example of how various tag values that may be associated with a single social media posting concerning a marketing lead prospect may be weighted when scoring the social media posting. Algorithms that assign different weights, utilize a different set of tags, and/or that have different or no mandatory tag requirements may be used instead.

FIG. 27 lists an example of how various tag values that may be associated with internal data from the internal databases 303 and that concern the author of the social media posting may be weighted when scoring the social media posting. Again algorithms that assign different weights, utilize a different set of tags, and/or that have different or no mandatory requirements may be used instead.

The weightings from all of the social media postings and from all of internal data tags may be combined by the algorithm to determine the lead score.

The determined lead score may then be stored in a computer data storage system, as reflected by a Store Score step 411. Thereafter, a determination may be made as to whether there are any additional leads to be scored, as reflected by a More Leads? Decision step 413. If so, the next lead may be processed in the same way as the lead that has been discussed above.

This lead scoring process may continue until all of the marketing leads that are of interest have been scored. Thereafter, a report may be provided and the highest scoring leads may be pursued with the marketing approach, as reflected by a Report On and Pursue Highest Scoring Leads step 415. The report may be printed or displayed. The leads in the report may be sorted based on their score. The report may include appropriate contact information for each lead.

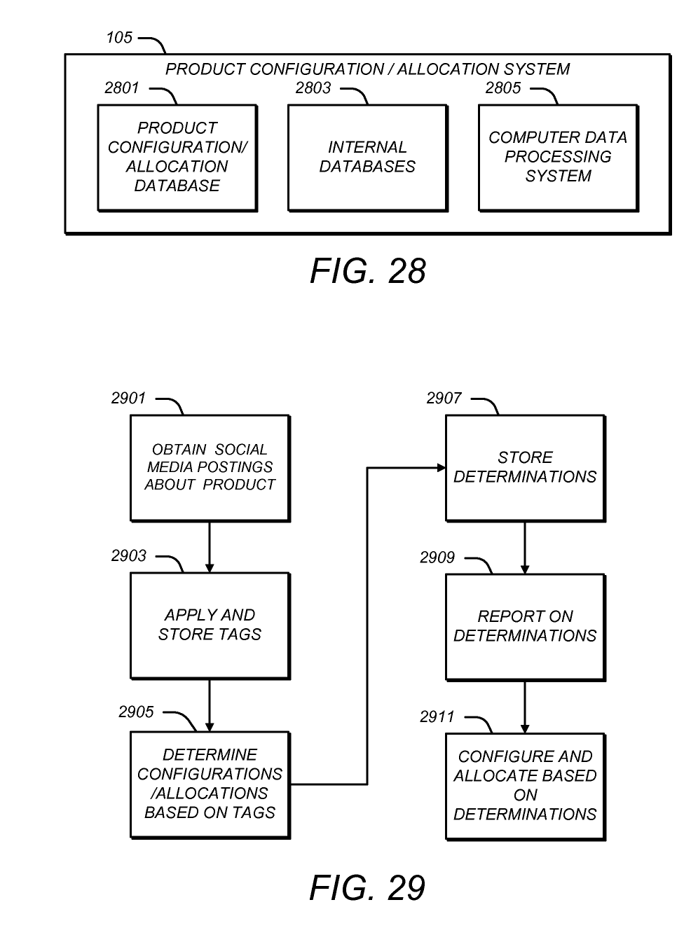

FIG. 28 illustrates an example of the product configuration/allocation system 105 illustrated in FIG. 1. As explained above, the product configuration/allocation system 105 may be configured to determine which products are likely to be most in demand. This may include which product options, accessories, and/or colors are likely to be most in demand.

As illustrated in FIG. 28, the system may include a product configuration/allocation database 2801, internal databases 2803, and a computer data processing system 2805.

The product configuration/allocation database 2801 may contain configuration information identifying various products and the various configurations that they may have. The available configurations may vary, for example, in terms of their options, accessories, and colors. The product configuration/allocation database 2801 may also contain information identifying various geographic locations to which the various products may be allocated (e.g., manufactured and/or delivered). The geographic locations may be specified in any way, such as by states, counties, cites, and/or towns and/or the name and/or location of various product manufacturers and dealers that may manufacturer or sell the products.

The internal databases 2803 may contain information relating to authors of social media postings that may be relevant to determining which products are likely to be most in demand, including which product options, accessories, and colors. These databases may be the same as or different from the internal databases 303 discussed above.

The computer data processing system 305 may be configured to perform the operations of the product configuration/allocation system 105 that are described herein, such as to issue queries, receive social media postings in response, associate tags, make determinations, and to cause actions to be taken based on the determinations. The computer data processing system 305 may be configured to perform each of the steps of the process illustrated in FIG. 29.

FIG. 29 illustrates an example of a process that may be implemented by the product configuration/allocation system illustrated in FIG. 28, such as by the computer data processing system 2805. This process may also be implemented by a different type of system. Similarly, the product configuration/allocation system illustrated in FIG. 29 may implement a different process.

The computer data processing system 2805 may seek social media postings about a product, as reflected by an Obtain Social Media Postings About Product step 3001. This may be done by the computer data processing system 205 formulating and causing the delivery of one or more queries to one or more sources of these social media postings, as more specifically discussed above. Each of these queries may seek social media postings that identify a product by its brand, series, and/or model.

The computer data processing system 2805 may analyze the social media postings that are received in response; tag those that contain information that may be relevant to which products, including their various options, accessories, and colors, are likely to be most in demand; and store these tags in a computer data storage system, as reflected by an Apply and Store Tags step 2903.

This analysis may look at a broad variety of different types of information within each retrieved social media posting that may be indicative of the relevancy of the social media posting to which of the products are likely to be in demand. This may include a search for some or all of the same types of search terms and the associating of the same tag values that have been discussed above in connection with the marketing lead prioritization system 103, such as the identification of products, purchase lifecycles, trusted recommendations, dealer visits, purchase target locations, life events, and other types of information. Again, moreover, sentiment analysis software may be used to extract desired sentiments about the various subjects that are of interest.

One difference may be that the analysis and tagging of the products that are identified in the social media postings may go down to a lower product level, such as to the level of identifying and tagging which options, accessories, and colors are referenced. Determining and tagging whether the social media postings express a positive or negative sentiment about each of these product variations may also be performed. Again, sentiment analysis software may be used to extract this information.

The geographic locations of the authors of the social media postings may also be identified and tagged. This may be done, for example, based on information in the social media postings, including metadata that is associated with them, and/or from other sources, such as the internal databases 2803 and/or other external databases, such as any of the types discussed above. This geographic information may enable the products of interest to be configured and/or allocated differently for each different target allocation location.

As with the marketing lead prioritization system 103 discussed above, moreover, other types of information from the internal databases 2803 and/or other external databases that may be relevant to determining which products are likely to be most in demand may also be identified and tagged.

All of the tags may then be analyzed to determine which of the products, including which options, accessories, and colors, are likely to be in most demand in general and/or in each of multiple geographic areas, as reflected by a Determine Configurations/Allocations Based On Tags step 2905. This may be done by the computer data processing system 2805 employing any algorithm that gives appropriate weights to the various tags and supplemental information. The algorithm may implement any of the approaches discussed above in connection with the Make Determination Based on Tags step 205.

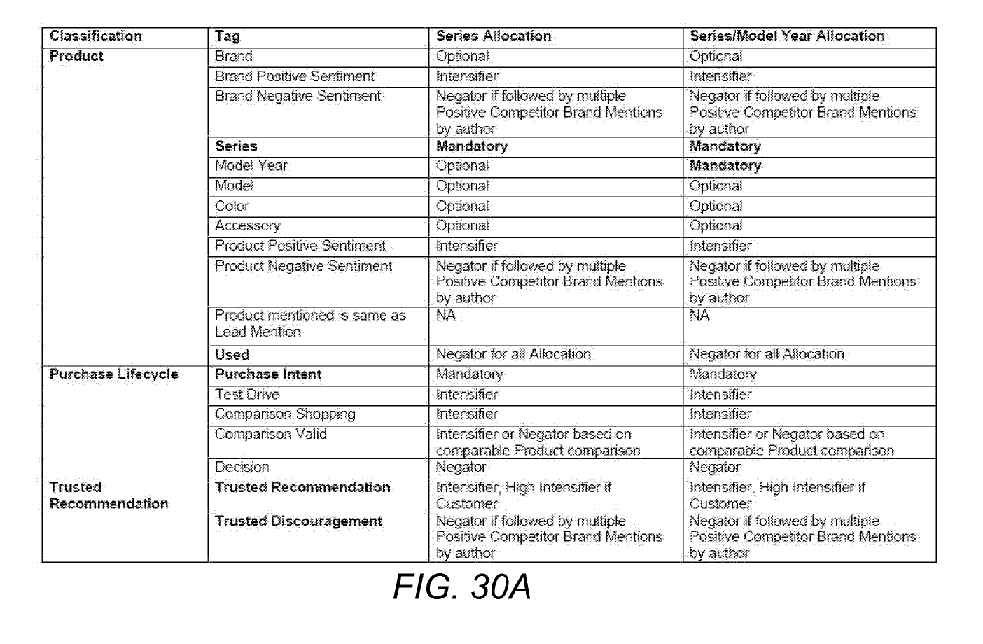

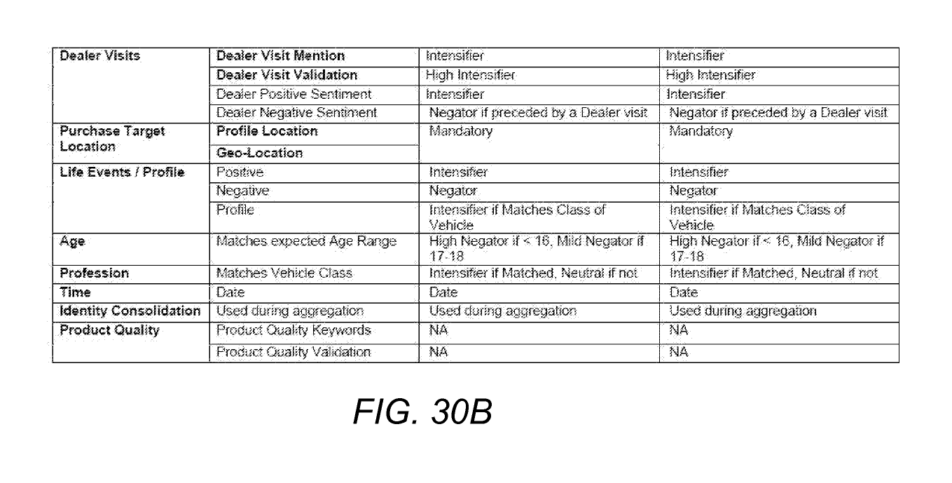

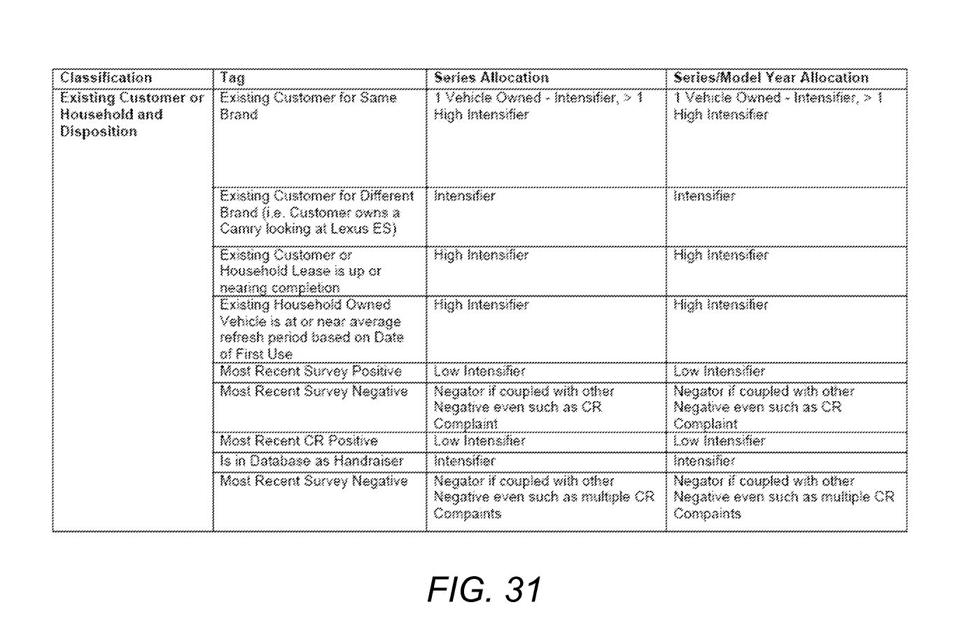

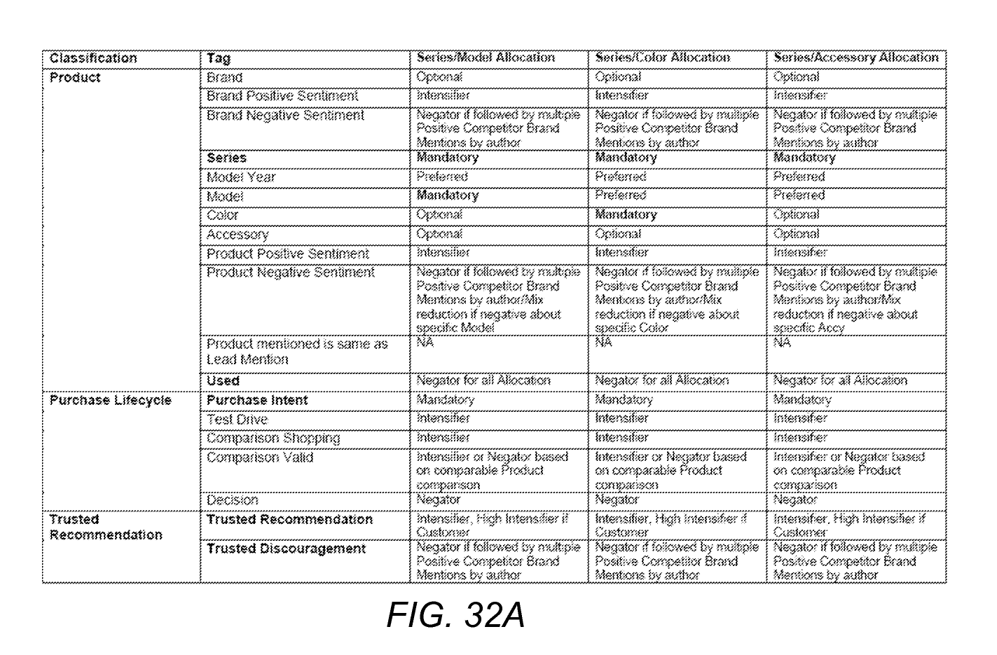

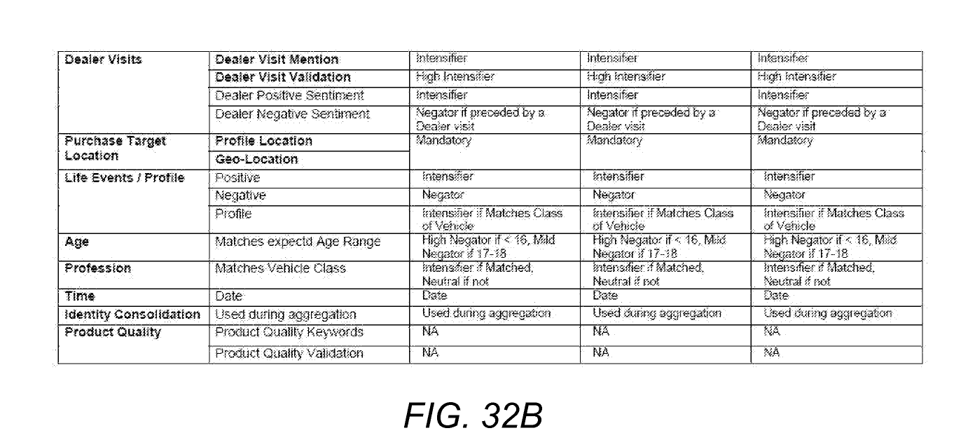

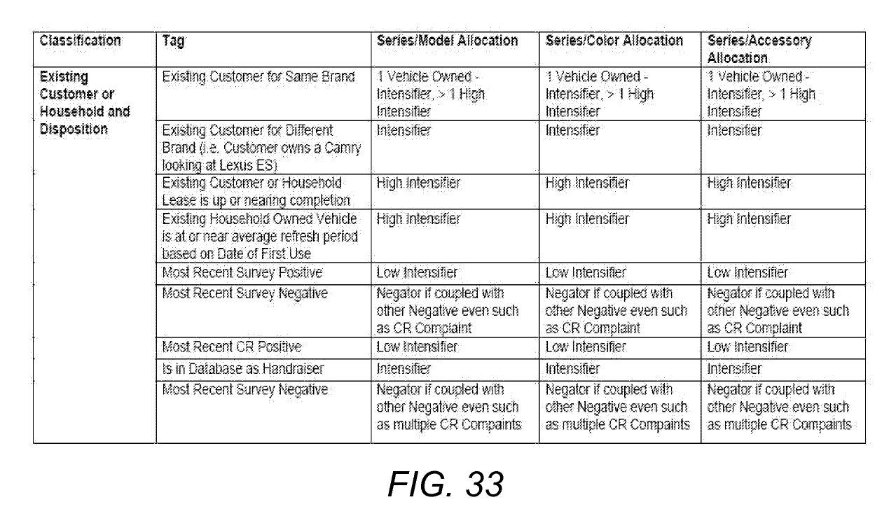

FIGS. 30A, 30B, 32A, and 32B collectively set forth an example of how various tag values that may be associated with a single social media posting may be weighted when scoring the social media posting for its effect on allocations of product series, product years, product models, product accessories, and product colors. (FIGS. 30A and 30B collectively constitute one table, while FIGS. 32A and 32B collectively constitute another.) Similarly, FIGS. 31 and 33 collectively set forth an example of how various tag values that may be associated with internal data from internal databases 2803 and that concern the author of the social media posting may effect the same product allocations.

The weighting from all of the social media postings and from all of the internal data tags may be combined by the algorithm when making the final determination.

These determinations may then be stored in a computer data storage system, as reflected by a Store Determinations step 2907. A report of these determinations may be printed and/or displayed, as reflected by a Report On Determinations step 2909. Orders for the various product series, product model years, product models, product accessories, and product colors may then be placed and allocated in proportion to the scores that each of these product variations received or based on a different weighting of these scores, as reflected by a Configure and Allocate Based On Determinations step 2911. As indicated above, a different set of determinations, configurations, and allocations may be made for each of the different geographic locations.

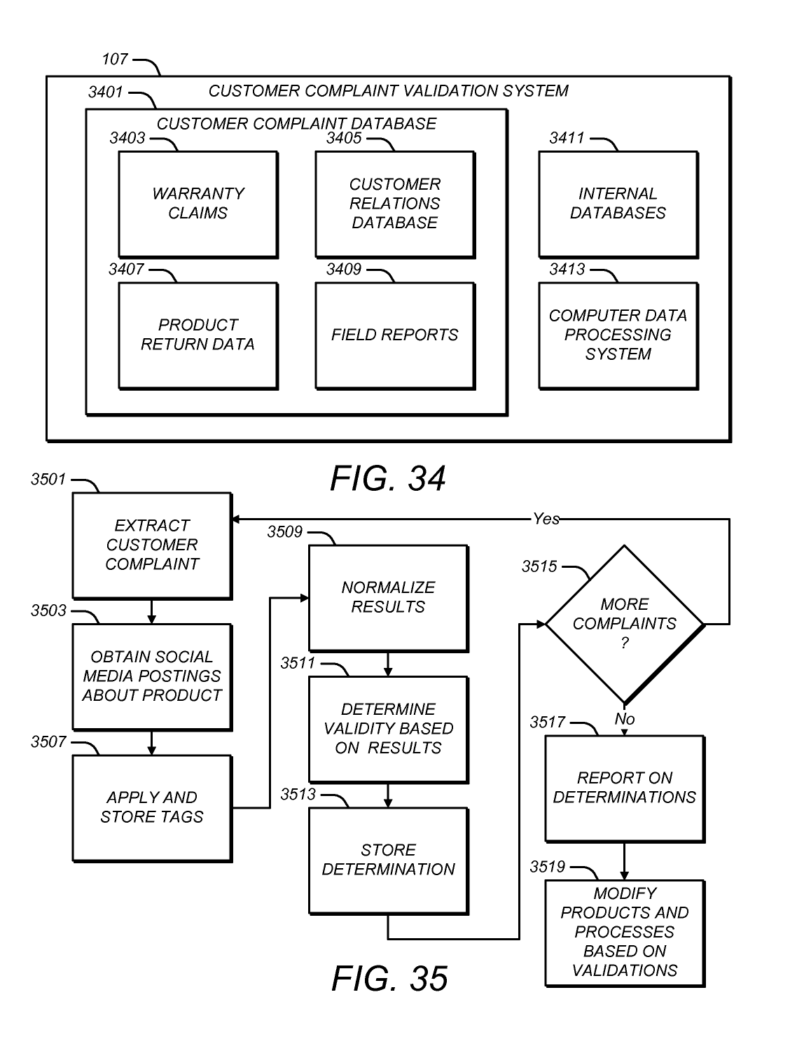

FIG. 34 illustrates an example of the customer complaint validation allocation system illustrated in FIG. 1. As explained above, the customer complaint validation system 107 may be configured to determine how widespread complaints are about products.

As illustrated in FIG. 34, the customer complaint validation system 107 may include a customer complaint database 3401, internal databases 3411, and a computer data processing system 3413.

The customer complaint database 3401 may include parts of several other databases, such as a warranty claims database 3403, a customer relations database 3405, a product return database 3407, and/or a field reports database 3409.

The customer complaint database 3401 may include information about customer complaints. The information about each customer complaint may include an identification of a product that is a subject of the complaint (e.g., a product brand, series, and/or model), an identification of an aspect of the product that is purportedly not meeting expectations, and a description of a problem with this aspect of the product. The information may also include an identification of the customer making the complaint.

The internal databases 3411 may contain information relating to the customers that have made the complaints that may be relevant to determining how widespread each complaint is. These databases may be the same as or different from the internal databases 303 discussed above.

The computer data processing system 3413 may be configured to perform the operations of the customer complaint validation system 107 that have been described herein, such as to issue queries, receive social media postings in response, associate tags, make determinations, and to cause actions to be taken based on the determinations. The computer data processing system 3413 may be configured to perform each of the steps of the process illustrated in FIG. 35.

FIG. 35 illustrates an example of a process that may be implemented by the complaint validation allocation system 107 illustrated in FIG. 34, such as by computer data processing system 3413. This process may also be implemented by a different type of system. Similarly, the complaint validation allocation system in FIG. 34 may implement a different process.

The computer data processing system 3413 may extract a customer complaint from the customer complaint database 3401, as reflected by an Extract Customer Complaint step 3501. This may include extracting an identification of the product that is a subject of the complaint, the aspect of the product that is purportedly not meeting expectations, the description of the problem with this aspect of the product, and the customer making the complaint.

The computer data processing system 3413 may seek social media postings about the identified product, as reflected by an Obtain Social Media Postings About Product step 3503. This may be done by the computer data processing system 3413 formulating and causing the delivery of one or more queries to one or more sources of these social media postings, as more specifically discussed above. Each of these queries may seek social media postings that identify a product by its brand, series, and/or model.

The computer data processing system 3413 may analyze the social media postings that are received in response; tag those that contain information that may be relevant to how widespread each complain is, and store these tags in a computer data storage system, as reflected by an Apply and Store Tags step 3005.

This analysis may look at a broad variety of different types of information within each retrieved social media posting that may be indicative of the relevancy of the social media posting to how widespread a complaint is. This may include a search for some or all of the same types of information that have been discussed above in connection with the marketing lead prioritization system 103, such as the identification of products, purchase target locations, and other types of information. This may also include an identification and tagging of social media postings that reference the aspect of the product that is a subject of the complaint. On the other hand, some of these types of information may not be deemed relevant and hence might be ignored, such as dealer visits and/or purchase intents.

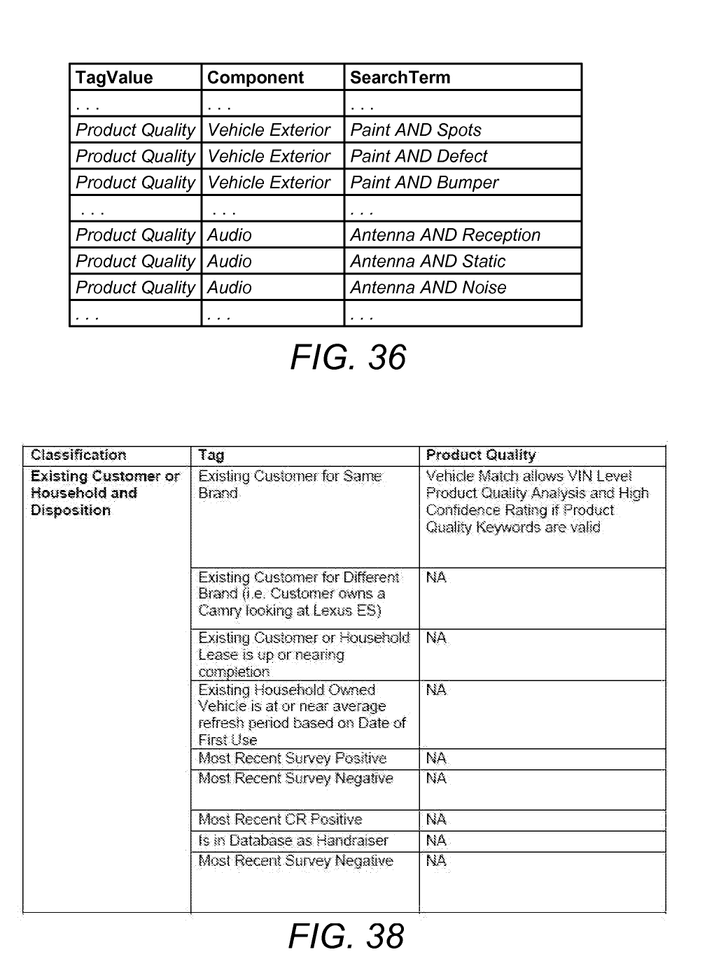

FIG. 36 illustrates an example of tags that may each be associated with social media postings that reference an aspect of a product that is described by the tag. Each tag may be associated with a list of term variations that are considered indicative of the aspect of the product that is referenced by the tag.

Once a social media posting has been determined to reference the same aspect of the product as the complaint, a determination may be made as to whether the social media posting has expressed the same complaint about this aspect of the product or, to the contrary, has spoken favorably about it. Keyword searching as well as sentiment analysis software may be used for this purpose. Appropriate tags may be added to reflect the results of this analysis.

The geographic locations of the authors of the social media postings may also be identified and tagged. This may be done, for example, based on information in the social media postings, in metadata that is associated with them, and/or from other sources, such as the internal databases 3411 and/or other external databases, such as any of the types discussed above. This geographic information may enable a determination to be made as to whether the compliant is widespread in each of several different geographic areas. In turn, this information may be relevant to identifying a production problem at a facility in one geographic area, but that may not exist in another facility.

As with the marketing lead prioritization system 103 discussed above, moreover, other types of information from the internal databases 3411 and/or other external databases may be relevant to determining how widespread the complaint is and this may also be identified and tagged.

The volume of tags that relate to each product complaint may be normalized to the number of products that were sold and that are potentially susceptible to the same complaint, as reflected by a Normalize Results step 3509. This may provide a more meaningful basis for evaluating the significance of the volume of complaint tags about the aspect of the product. In other words, a small number of complaints in the social media postings may be deemed more significant if only a small number of that type of product has been sold. This normalization step may be performed separately with respect to each geographic area that is of interest. For example, a numerator of a fraction may contain the number of complaints of a particular type about a particular series/model year, while the denominator might contain the number of such series/model that were sold in that year. The fraction could then be rationalized to reflect the number of such complaints per 100, 1000, or other number of vehicles.

The validity of the complaint may next be determined based on the normalized volume of tags, as reflected by a Determine Validity Based On Results step 3511. This may be done by the computer data processing system 3413 employing any algorithm that gives appropriate weights to the various tags and supplemental information. The algorithm may implement any of the approaches discussed above in connection with the Make Determination Based on Tags step 205.

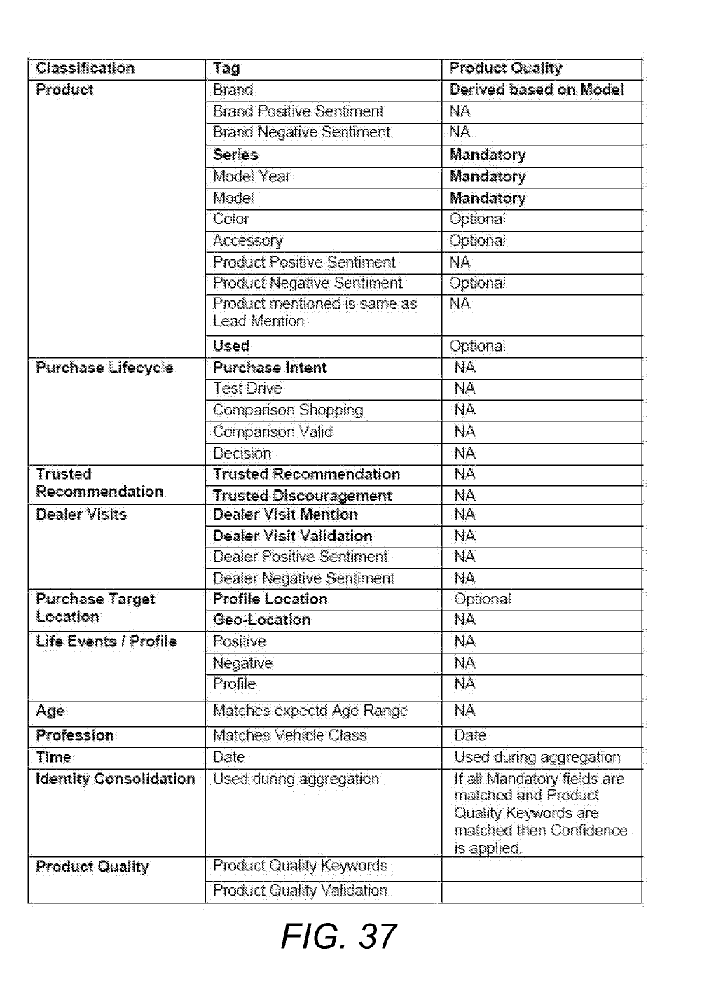

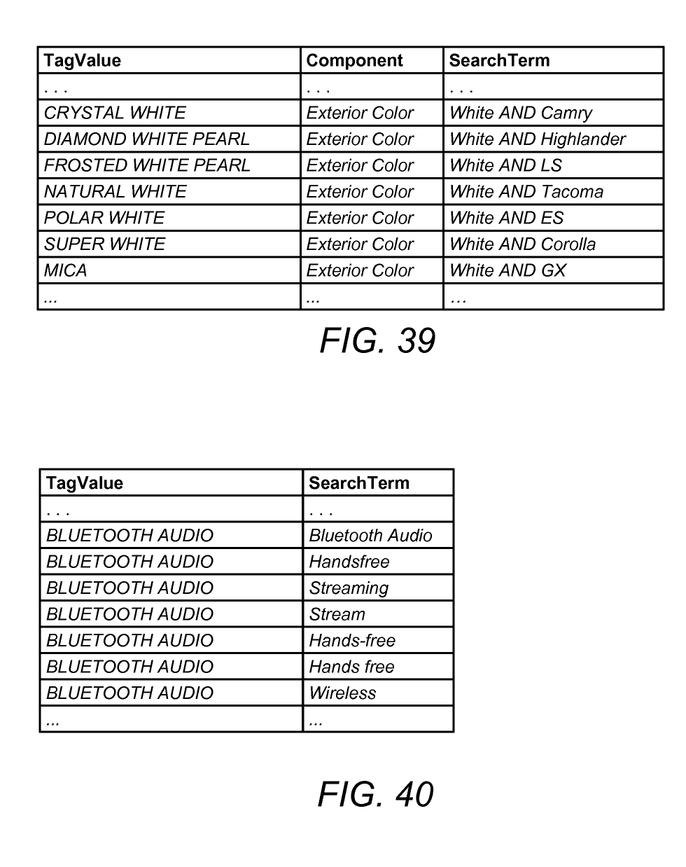

FIG. 37 presents an example of how various tag values that may be associated with a social media posting concerning a product complaint may be weighted when scoring the social media posting. Other algorithms that assign different weights, utilize a different set of tags, and/or that have different or no mandatory requirements may be used instead.

Various other factors may be considered in weighing the importance of social media postings. For example, greater weight may be given to results that concern complaints from existing customers then complaints from mere potential customers.

FIG. 37 presents an example of how various tag values that may be associated with internal data from internal databases 3411 and that concern product complaints may be weighted when scoring the social media posting. Again, other algorithms that assign different weights, utilize a different set of tags, and/or that have different or no mandatory requirements may be used instead.

The weighting from all of the social media postings and from all of the internal data tags may be combined by the algorithm when making the final determination. The determination of whether the complaint is widespread may be expressed by a score that is indicative of the degree to which the complaint is widespread.

The determination which is reached may be stored in a computer data storage system, as reflected by a Store Determination step 3513.

A determination may be made as to whether there are other complaints to analyze, as reflected by a More Complaints? decision step 3515. If there are, the next complaint may be analyzed using the same process. Otherwise, a report may be provided, as reflected by a Report On Determinations step 3517. The complaints in the report may be sorted based on the degree to which they have been determined to be widespread and/or by the geographic regions in which they have been determined to be widespread.

The products that are determined to be the subject of widespread complaints, and/or the processes that are used to make them, may then be modified to correct the aspects about them that have caused the complaints, as reflected by a Modify Products and Processes Based On Validations step 3519.

FIG. 39 illustrates an example of tags that may each be associated with social media postings that reference a color of a product that is described by the tag. Each tag may also be associated with a value that indicatives the part of the product to which the tag is in reference. As reflected in FIG. 39, the search may include a series name when different shades of the same color.

FIG. 40 illustrates an example variations in search terms that may be used with social media postings that reference an accessory for a product, along with an example of tags that may used with them.

The business information system 101, including the marketing lead prioritization system 103, the product configuration/allocation system 105, and the customer complaint validation system 107, as well as each of their respective computer data processing systems, may each be implemented with a computer system configured to perform the functions that have been described herein for the component. Each computer system includes one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Each computer system may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and advantages. These also include embodiments in which the components and/or steps are arranged and/or ordered differently.

For example, the same system may be used to determine customer vehicle styling preferences which could in turn be used to improve future vehicle designs. The same system could also be used to understand competitive product features favored by both new and existing customers. This information can be analyzed and provided to product planning to evaluate possible opportunities for product improvement. The system can also be used to try and decrease customer losses by providing engagement opportunities with existing customers whom have expressed dissatisfaction with Toyota products.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A system for determining configurations and/or allocations of products comprising:
a computer data processing system configured to:
query a computer system for social media postings made in a social media network system that are about one or more of the products;
determine which of the products are likely to be most in demand based on the results of the query; and
store information indicative of the determination.

2. The system for determining configurations and/or allocations of claim 1 wherein the computer data processing system is configured to tag each social media posting that contains information relevant to which of the products are likely to be most in demand.

3. The system for determining configurations and/or allocations of claim 1 wherein the computer data processing system is configured to:
determine which product options are likely to be most in demand based on the results of the query; and
store information indicative of which product options are likely to be most in demand.

4. The system for determining configurations and/or allocations of claim 3 wherein the computer data processing system is configured to:
determine which product color or colors are likely to be most in demand based on the results of the query; and
store information indicative of which product color or colors are likely to be most in demand.

5. The system for determining configurations and/or allocations of claim 1 wherein the computer data processing system is configured to:
determine a location of the author of each of the social media postings that are about one or more of the products; and
determine which of the products are likely to be most in demand at each of multiple locations based on the results of the query and the location determinations; and
store information indicative of which of the product are likely to be most in demand at each of the multiple locations.

6. The system for determining configurations and/or allocations of claim 1 wherein the computer data processing system is configured to:
identify each social media posting that contains information indicative of a positive or negative sentiment about one of the products; and
determine which of the products are likely to be most in demand based at least in part on the identified sentiments.

7. The system for determining configurations and/or allocations claim 1 wherein the computer data processing system is configured to:
identify each social media posting that contains information indicative of an intention to purchase one of the products; and
determine which of the products are likely to be most in demand based at least in part on the identified intentions to purchase.

8. The system for determining configurations and/or allocations of claim 1 wherein the computer data processing system is configured to:
identify each social media posting that contains information indicative of a comparison between two of the products; and
determine which of the products are likely to be most in demand based at least in part on the identified comparisons.

9. The system for determining configurations and/or allocations of claim 8 wherein the computer data processing system is configured to:
identify each social media posting that contains information indicative of a comparison between two of the products;
determine whether each identified comparison is between products within substantially the same class; and
determine which of the vehicle models are likely to be most in demand based at least in part on the same class determinations.

10. The system for determining configurations and/or allocations of claim 1 wherein the computer data processing system is configured to:
query the computer system for social media postings in the social media network that were made to each of the authors of the social media postings that are about one or more of the products;
identify those social media postings made to each of the authors that contain information indicating a recommendation for or against a particular one of the products; and
determine which of the products are likely to be most in demand based at least in part on the identified recommendations.

11. The system for determining configurations and/or allocations of claim 10 wherein the computer data processing system is configured to obtain the social media postings made to each of the authors by querying the computer system for social media postings that were made in response to social media postings made by each of the authors.

12. The system for determining configurations and/or allocations of claim 10 wherein the computer data processing system is configured to obtain the social media postings made to each of the authors by querying the computer system for social media postings made to each author in an area of the social media network system dedicated to each of the authors and in which others may post postings.

13. The system for determining configurations and/or allocations of claim 1 wherein the computer data processing system is configured to:
identify each social media posting that contains information indicative of an event in the life of each author of the social media posting that is relevant to determining whether each author is likely to purchase one of the products; and
determine which of the products are likely to be most in demand based at least in part on the identified events.

14. The system for determining configurations and/or allocations of claim 1 wherein the computer data processing system is configured to:
identify each social media posting that contains information indicative of a visit to a product dealer by each of authors of the social media postings; and
determine which of the products are likely to be most in demand based at least in part on the identified visits.

15. The system for determining configurations and/or allocations of claim 14 wherein the computer data processing system is configured to:
verify the accuracy of the information indicative of the visit to each product dealer; and
determine which of the products are likely to be most in demand based at least in part on the verifications.

16. A non-transitory, tangible, computer-readable storage medium containing a program of instructions configured to cause a computer data processing system running the program of instructions to determining configurations and/or allocations of products, and, in particular, to:
query a computer system for social media postings made in a social media network system that are about one or more of the products;
determine which of the products are likely to be most in demand based on the results of the query; and
store information indicative of the determination.

17. The storage medium of claim 16 wherein the program of instructions are configured to cause the computer data processing system to tag each social media posting that contains information relevant to which of the products are likely to be most in demand.

18. The storage medium of claim 16 wherein the program of instructions are configured to cause the computer data processing system to:
determine which product options are likely to be most in demand based on the results of the query; and
store information indicative of which product options are likely to be most in demand.

19. The storage medium of claim 18 wherein the program of instructions are configured to cause the computer data processing system to:
determine which product color or colors are likely to be most in demand based on the results of the query; and
store information indicative of which product color or colors are likely to be most in demand.

20. The storage medium of claim 16 wherein the program of instructions are configured to cause the computer data processing system to:
determine a location of the author of each of the social media postings that are about one or more of the products; and
determine which of the products are likely to be most in demand at each of multiple locations based on the results of the query and the location determinations; and
store information indicative of which of the product are likely to be most in demand at each of the multiple locations.

21. The storage medium of claim 16 wherein the program of instructions are configured to cause the computer data processing system to:
identify each social media posting that contains information indicative of a positive or negative sentiment about one of the products; and
determine which of the products are likely to be most in demand based at least in part on the identified sentiments.

22. The storage medium of claim 16 wherein the program of instructions are configured to cause the computer data processing system to:
identify each social media posting that contains information indicative of an intention to purchase one of the products; and
determine which of the products are likely to be most in demand based at least in part on the identified intentions to purchase.

23. The storage medium of claim 16 wherein the program of instructions are configured to cause the computer data processing system to:
identify each social media posting that contains information indicative of a comparison between two of the products; and
determine which of the products are likely to be most in demand based at least in part on the identified comparisons.

24. The storage medium of claim 23 wherein the program of instructions are configured to cause the computer data processing system to:
identify each social media posting that contains information indicative of a comparison between two of the products;
determine whether each identified comparison is between products within substantially the same class; and
determine which of the vehicle models are likely to be most in demand based at least in part on the same class determinations.

25. The storage medium of claim 16 wherein the program of instructions are configured to cause the computer data processing system to:
query the computer system for social media postings in the social media network that were made to each of the authors of the social media postings that are about one or more of the products;
identify those social media postings made to each of the authors that contain information indicating a recommendation for or against a particular one of the products; and
determine which of the products are likely to be most in demand based at least in part on the identified recommendations.

26. The storage medium of claim 25 wherein the program of instructions are configured to cause the computer data processing system to obtain the social media postings made to each of the authors by querying the computer system for social media postings that were made in response to social media postings made by each of the authors.

27. The storage medium of claim 25 wherein the program of instructions are configured to cause the computer data processing system to obtain the social media postings made to each of the authors by querying the computer system for social media postings made to each author in an area of the social media network system dedicated to each of the authors and in which others may post postings.

28. The storage medium of claim 16 wherein the program of instructions are configured to cause the computer data processing system to:
identify each social media posting that contains information indicative of an event in the life of each author of the social media posting that is relevant to determining whether each author is likely to purchase one of the products; and
determine which of the products are likely to be most in demand based at least in part on the identified events.

29. The storage medium of claim 16 wherein the program of instructions are configured to cause the computer data processing system to:
identify each social media posting that contains information indicative of a visit to a product dealer by each of authors of the social media postings; and
determine which of the products are likely to be most in demand based at least in part on the identified visits.

30. The storage medium of claim 29 wherein the program of instructions are configured to cause the computer data processing system to:
verify the accuracy of the information indicative of the visit to each product dealer; and
determine which of the products are likely to be most in demand based at least in part on the verifications.
